(19) United States
(12) Patent Application Publication
(10) Pub. No.: US 2026/0129407 A1
(43) Pub. Date: May 7, 2026

(54) SPACE RESERVATION

(71) Applicant: FRAMERY OY, Tampere (FI)

(72) Inventors: Annika VÄNSKÄ, Lempäälä (FI); Ulla OKSANEN, Tampere (FI); Ari MONONEN, Lempäälä (FI)

(73) Assignee: FRAMERY OY, Tampere (FI)

(21) Appl. No.: 19/117,454

(22) PCT Filed: Sep. 22, 2023
(86) PCT No.: PCT/FI2023/050541

§ 371 Date: Apr. 1, 2025

(30) Foreign Application Priority Data
Oct. 13, 2022 (FI) 20225927

(51) Int. Cl. H04W 4/30; H04W 4/029

(52) U.S. Cl. CPC H04W 4/30; H04W 4/029

(57) ABSTRACT

A method, an apparatus and a computer program for providing a space to speak on a call, wherein an indication of an incoming call is received at a mobile device, and in response to receiving the indication of the incoming call at the mobile device, it is indicated to a user whether an available space exists for the user to speak on the call.

### TECHNICAL FIELD

The present disclosure generally relates to reservation of space.

### BACKGROUND

This section illustrates useful background information without admission of any technique described herein representative of the state of the art.

When a person receives a call, for instance in an office, and wishes to talk privately it may be difficult to find a vacant space. The call may be for instance a call on a mobile device, such as a mobile phone. Presently, the person would typically look for a vacant space by walking to different spaces to see whether they are vacant or in use. This may be difficult and time consuming.

There are reservation systems, in which one may book a vacant space in advance for a meeting. However, these systems are of little use in the event one does not know exact timings of received phone calls in advance.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided a method for providing a space to speak on a call, the method comprising:
receiving an indication of an incoming call at a mobile device; and
in response to receiving said indication of the incoming call at the mobile device, indicating to a user whether an available space exists for the call.

Accordingly, said indicating regarding the available space to the user may e.g. comprise the mobile device showing identification information of an available office pod (where the user can privately take the call) to the person using the mobile device.

In certain embodiments, there are two types of spaces. Spaces of a first type can be booked, and spaces of a second type cannot be booked. Accordingly, in certain embodiments, when indicating (by the mobile device, e.g., on the screen of the mobile device) whether an available space exists, the mobile device also indicates whether the space can be booked.

In certain embodiments, the method further comprises enabling for the user to book the available space (such as an office pod).

In certain embodiments, the indicating regarding the available space to the user and/or the enabling for the user to book the available space comprises using an application.

Accordingly, in certain embodiments, the method comprises in response to receiving the indication of the incoming call at the mobile device, activating (e.g., opening/initiating) an application at the mobile device for indicating whether an available space exists for the call.

In certain embodiments, the said application is an application at the mobile device. In certain embodiments, the said application is a space-booking application (or a space reservation application). In other embodiments, the mobile device directly connects with spaces without using a separate application at the mobile device end. In such embodiments, the spaces themselves may contain an appropriate application or applications that control reservation of the spaces (and optionally monitor presence information of the spaces). One or more of the preceding applications may form part of a space reservation system administering the available spaces. In further embodiments, the mobile device directly connects with a space reservation system (or systems) without using a separate application. In certain embodiments, the mobile device gathers information on available spaces e.g. by using the preceding application(s)/system(s).

In certain embodiments, the indication of an incoming call is received from a network, such as a mobile telephony or communications network. In certain embodiments, the indication causes an action at the mobile device, such as generating a ringing tone. In certain embodiments, the indication enables for the mobile device (and its user) to know that a call is incoming.

In certain embodiments, the received indication of an incoming call functions in the mobile device as a trigger for indicating an available space (or its existence) for the user (with the aid of the mobile device).

In certain embodiments, the received indication of an incoming call functions in the mobile device as a trigger enabling booking a space for the user (with the aid of the mobile device). In certain embodiments, the received indication triggers a space-booking action within the mobile device.

In certain embodiments, the mobile device is a (mobile) phone. In certain embodiments, the mobile device is a tablet. In certain embodiments, the mobile device is a laptop computer.

In certain embodiments, the method comprises showing or identifying to the user vacant spaces nearby. In certain embodiments, the method comprises showing or identifying to the user a plurality of vacant spaces nearby. In certain embodiments, the method further comprises enabling for the user to choose a vacant space (and the mobile device to receive the choice made by the user). In certain embodiments, the method further comprises suggesting for the user a vacant space nearby. In certain embodiments, the method further comprises enabling for the user to confirm a suggested vacant space. In certain embodiments, the method further comprises showing or identifying to the user occupied spaces nearby. In certain embodiments, the preceding functions are implemented and/or enabled by said application at the mobile device.

In certain embodiments, the booking is performed without first indicating the existence of an available space for the user. Accordingly, in certain embodiments, the method comprises booking an available space without user interaction in response to receiving the indication of the incoming call.

In certain embodiments, the method allows the user to store preferences of the places. In certain embodiments, the method comprises pre-selecting an available space in accordance with a stored user preference.

In certain embodiments, the method further comprises showing to the user the duration until the space nearby has the next booking (or will next be occupied). In certain embodiments, the method further comprises showing to the user the duration until an occupied space nearby is vacated again.

In certain embodiments, the method further comprises enabling for the user to select the mobile device to show all vacant spaces nearby. In certain embodiments, the method further comprises providing for the user an input feature in the mobile device, such as a button, to show all vacant spaces nearby in response to activating the input feature. In certain embodiments, the method further comprises the application proposing (i.e. suggesting) to the user a vacant space nearby. In certain embodiments, the method further comprises the application proposing to the user a plurality of vacant spaces nearby.

In certain embodiments, the user is provided with a disabling feature to prevent the application from showing vacant spaces (by activating the disabling feature at the mobile device if the user so wishes).

In certain embodiments, the method further comprises enabling for the user to book a vacant space of the user's choice. In certain embodiments, the method further comprises enabling for the user to confirm booking of a vacant space suggested by the mobile device/application. In other embodiments, as mentioned in the preceding, the method further comprises booking a vacant space without user interaction in response to receiving the indication of an incoming call.

In certain embodiments, the application shows to the user locations of the vacant space(s). This enables the user to choose the vacant space based on the location. In certain embodiments, the method further comprises providing guidance to the user on how to arrive at the vacant or the booked space. In certain embodiments, the provided guidance is implemented by a map e.g. at the application.

In certain embodiments, the method further comprises providing a visible indication of the location and/or the vacancy of the space. In certain embodiments, the visible indication is attached to the space. In certain embodiments, the visible indication is a sign. In certain embodiments, the visible indication is a display. In certain embodiments, the visible indication is a shape. In certain embodiments, the visible indication is a light. In certain embodiments, the visible indication comprises a colour indicator whose colour indicates whether the space is vacant or not. The visible indication makes it easier for the user to locate the space, for example in an unfamiliar environment.

In certain embodiments, the method comprises indicating (prior to an actual selection of an available space for the call) an available space (or a plurality of available spaces) to the user both by the mobile device and, simultaneously, by the available space itself (or by the plurality of available spaces themselves).

In certain embodiments, the call is a phone call. In certain embodiments, the call is a video call. In certain embodiments, the call is a conference call. In certain embodiments, the call is from a video conferencing tool or from a video call program.

In certain embodiments, the space is a confined space. In certain embodiments, the space is a booth. In certain embodiments, the space is an office booth (office pod). In another embodiment, the space is a meeting room or a meeting booth.

In certain embodiments, the method further comprises making the booked space available for others after the user has left the booked space after the call. In certain other embodiments, the method comprises not making the booked space available for others after the call if the user has not yet left the space.

According to a second example aspect there is provided an apparatus comprising a processor, and a memory including computer program code, the memory and the computer program code configured to, with the processor, cause the apparatus to perform the method of the first aspect.

According to a third example aspect there is provided a computer program comprising computer executable program code which when executed by a processor causes an apparatus of the second aspect to perform the method of the first aspect.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments and features apply to other example aspects as well. In particular, the embodiments and features described in the context of the first aspect are applicable to each further aspect, and vice versa. Any appropriate combinations of the embodiments may be formed.

### BRIEF DESCRIPTION OF THE FIGURES

Some example embodiments will be described with reference to the accompanying figures, in which:

FIG. 1 schematically shows an example in accordance with certain embodiments;

FIG. 2 shows a flow chart in accordance with certain embodiments;

FIG. 3 shows an apparatus in accordance with certain embodiments;

FIG. 4 shows an example of determining available spaces from a space reservation system according to an embodiment; and

FIG. 5 shows an example of a mobile device according to an embodiment.

### DETAILED DESCRIPTION

In the following description, like reference signs denote like elements or steps.

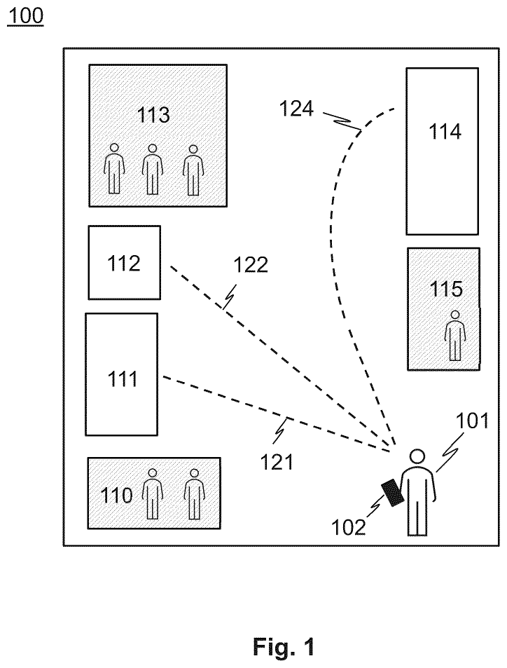

FIG. 1 shows schematically an example according to an embodiment. The user 101 is in an office 100. In certain embodiments, the office 100 comprises a large open area. In other embodiments, the office comprises hallways and a plurality of open areas. In certain embodiments, the office comprises a plurality of small areas, for instance, confined spaces. In certain embodiments, the confined spaces are in the form of a plurality of office rooms, such as meeting rooms and/or office booths. FIG. 1 shows the user 101 is in a large open area comprising a plurality of office booths 110-115 representing spaces that may be booked.

In a method in accordance with certain embodiments, the user 101 receives an indication of an incoming call at their mobile device 102. In certain embodiments, the indication causes an action at the mobile device, such as generating a ringing tone. In certain embodiments, the indication enables for the mobile device (and its user) to know that a call is incoming. In certain embodiments, the call is a phone call, a video call, a conference call, or a call from a video conferencing tool or from a video call program.

In certain embodiments, in response to receiving the indication of the incoming call at the mobile device 102, it is indicated to a user 101 whether an available space exists. In certain embodiments, it is further enabled for a user 101 to book a space. In certain embodiments, there is an appropriate application (not shown in FIG. 1) at the mobile device 102 assisting in said indicating and/or booking. The received indication functions in the mobile device 102 as a trigger for indicating an available space and/or as a trigger enabling booking a space for the user. In certain embodiments, the received indication triggers a space-booking action within the mobile device 102. In certain embodiments, said space-booking action comprises activating the said application. For example, in certain embodiments, the mobile device 102 opens the application and the application indicates to the user whether an available space exists. Further, in certain embodiments, the mobile device 102 opens the application and the application enables for the user 101 to book a space. In certain embodiments, the said application is a space-booking application, or a space reservation application. In certain embodiments, the application is connected to a space-booking (i.e. reservation) system. In certain embodiments, the space booking system administers the available spaces.

In the example embodiment of FIG. 1, there are in total six spaces 110, 111, 112, 113, 114, 115 inside the room 100. In certain embodiments, the spaces are, for instance, office booths. In certain embodiments, as a response to receiving the indication of the incoming call at the mobile device 102, the mobile device 102 activates (i.e. opens/initiates) the application at the mobile device 102. In certain embodiments, the application shows to the user 101 vacant spaces nearby, or a plurality of vacant spaces nearby. In the example embodiment of FIG. 1, the application on the user's 101 mobile device 102 shows three vacant spaces 111, 112, 114 nearby. The application enables for the user to book a space. In certain embodiments, the application enables for the user 101 to choose a vacant space 111, 112, or 114 from the application. In the example embodiment of FIG. 1, the user 101 books a vacant space of one's choice in the application. In an alternative embodiment, the application itself books a vacant space immediately, without user interaction, as a response to receiving the indication of the call to the mobile device 102. In a yet alternative embodiment, the application suggests for the user 101 a vacant space nearby (i.e. vacant space 111, 112, or 114), and the application asks the user 101 to confirm the suggested vacant space (as pre-selected by the application). In certain embodiments, the application provides the user with a possibility to store a preference of places beforehand. The application the pre-selects an available space in accordance with the stored user preference.

In certain embodiments, the application enables for the user 101 to select the mobile device 102 to show all vacant spaces 111, 112, 114 nearby. In certain embodiments, the method further comprises providing for the user 101 an input feature in the mobile device 102, such as a button, to show all vacant spaces 111, 112, 114 nearby in response to activating the input feature.

In certain embodiments, in case the user 101 does not want to see the vacant spaces 111, 112, 114 nearby as a response to receiving the indication of the call, the user 101 can prevent the application on the mobile device 102 from showing vacant spaces.

In certain embodiments, the application at the mobile device 102 also shows to the user 101 the occupied spaces 110, 113, 115 nearby. In certain embodiments, the application on the mobile device 102 shows also to the user 101 the duration until an occupied space 110, 113, 115 nearby is vacated again. In certain embodiments, the application shows to the user 101 the duration until the space nearby has the next booking (or will next be occupied).

In certain embodiments, the application at the mobile device 102 shows to the user 101 locations of the vacant spaces 111, 112, 114. This enables the user to choose the vacant space based on the location. In certain embodiments, the application provides guidance 121, 122, 124 to the user 101 on how to arrive at the vacant or booked space 111, 112, 114. In certain embodiments, the guidance 121, 122, 124 is implemented by a map at the mobile device 102. In certain embodiments, the guidance 121, 122, 124 is implemented by a wearable augmented reality (AR) device, such as by AR-glasses. In certain embodiments, the guidance 121, 122, 124 is implemented by a voice control at the mobile device 102 or at a handsfree device connected to the mobile device 102.

In certain embodiments, a visible indication of the location and/or the vacancy of the space is provided (not shown). In certain embodiments, the visible indication is attached to the space. In certain embodiments, the visible indication is a sign, a display, a shape, or a light. In certain embodiments, the visible indication comprises a colour indicator whose colour indicates whether the space is vacant or not. The visible indication makes it easier for the user 101 to locate the space, for example in an unfamiliar environment.

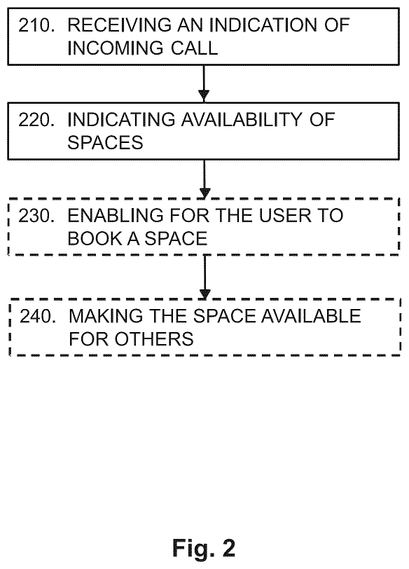

FIG. 2 shows a flow chart in accordance with certain embodiments. In the first step 210, an indication of an incoming call is received at a mobile device. As a response to receiving the indication of the incoming call, it is indicated to the user whether an available space exists in step 220. This indication may be performed directly or in an indirect manner. For example, the mobile device suggesting the user to select an available space already contains the indication that an available space exists. In certain embodiments, to the user is shown the vacant spaces nearby, and the user is allowed to choose which space they would like to book. In certain embodiments, there are two types of spaces. Spaces of a first type can be booked, and spaces of a second type cannot be booked. However, the availability of the spaces of both types can be indicated. Accordingly, the user is optionally enabled to book an available space in step 230, whereafter the space is booked and the user may privately talk in the call in the booked space.

According to further embodiments, after the call, the booked space is made available for other users once the user has left the booked space after the call has ended (optional step 240). In certain other embodiments, the booked space is not made available for others after the call if the user has not yet left the space. For discovering whether the user still is within the booked space, presence data provided by the booked space (such as an office booth) may be used. In certain embodiments, the said application (space-booking application) communicates with the space-booking system, and indicates to the system of a termination of the call. For example, based on this indication and/or based on the presence data, the space-booking system in certain embodiments frees the booked space so that it becomes available for others after the user has left the space.

In certain embodiments, when it is indicated to the user whether an available space exists (in the step 220), the available space(s) simultaneously provide the user with a visible indication (e.g., a sign, a display, a shape, or a light) of their existence. In this way, once the user gets the indication (e.g. as list of available spaces) at the display of the mobile device that there are available space(s), the user may visually detect the location of one or more of the available spaces already then. This can be beneficial especially in places that are unfamiliar to the user.

When the spaces show their availability with said visible indication, this visible indication in certain embodiments is different for each space. In certain embodiments, this indication is also shown correspondingly in the list of available spaces on the display of mobile device (so that the user will be able to match the available space providing said visible indication with the available space as appearing in the list).

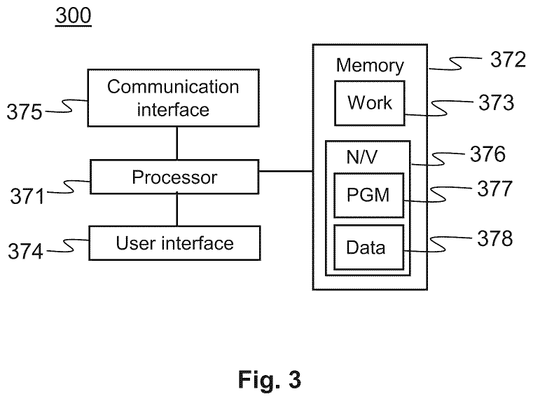

FIG. 3 shows an apparatus in accordance with certain embodiments. The apparatus 300 can be used for implementing embodiments of the invention. In certain embodiments, the shown apparatus 300 is, inter alia, capable of performing the steps of the first example aspect. The apparatus 300 may be for example a general-purpose computer or some other electronic data processing apparatus. In certain embodiments, the apparatus 300 is capable of receiving a call. In certain embodiments, the apparatus 300 is a mobile device, in particular a mobile phone, a tablet, or a laptop computer. In other embodiments, the apparatus 300 represents more of a system comprising elements at separate locations.

The apparatus 300 comprises a communication interface 375, at least one processor 371, a user interface 374, and at least one memory 372. The communication interface 375 comprises in certain embodiments a wired and/or wireless communication circuitry, such as Ethernet, Wireless LAN or WI-FI, Bluetooth, GSM, CDMA, WCDMA, LTE, and/or 5G circuitry. The communication interface 375 can be integrated in the apparatus 300 or provided as a part of an adapter, card or the like, that is attachable to the apparatus 300. In certain embodiments, the communication interface 375 supports one or more different communication technologies. In certain embodiments, the apparatus 370 also or alternatively comprises more than one communication interface 375. In certain embodiments, the at least one processor 371 is a central processing unit (CPU), a microprocessor, a digital signal processor (DSP), a graphics processing unit, an application specific integrated circuit (ASIC), a field programmable gate array, a microcontroller, or the like, or a combination of such elements. In certain embodiments, the user interface 374 comprises a circuitry for receiving input from a user of the apparatus 300, e.g., via a keyboard, graphical user interface shown on the display of the apparatus 300, speech recognition circuitry, microphone, or an accessory device, such as a headset, and for providing output to the user via, e.g., a graphical user interface.

The at least one memory 372 comprises a work memory 373 and a persistent (non-volatile, N/V) memory 376 configured to store computer program code 377 and data 378. As to the described method, in certain embodiments, the at least one processor 371 as instructed by the program code 377 notices the incoming call and causes the said activation of the said application (space-booking application also stored in the memory 372/376). The user is informed about the availability of spaces at a display of the user interface 374. And further, the user is enabled to book a space or to confirm booking e.g. at the display. In certain embodiments, the data 378 comprises the said user preferences that may be used to control the space-booking application. In certain embodiments, the memory 376 comprises any one or more of: a read-only memory (ROM), a programmable read-only memory (PROM), an erasable programmable read-only memory (EPROM), a random-access memory (RAM), a flash memory, a data disk, an optical storage, a magnetic storage, a smart card, a solid state drive (SSD), or the like. In certain embodiments, the apparatus 300 comprises a plurality of memories 376. In certain embodiments, the memory 376 is constructed as a part of the apparatus 300 or as an attachment to be inserted into a slot, port, or the like of the apparatus 300 by a user or by another person or by a robot. In certain embodiments, the memory 376 serves the sole purpose of storing data, or be constructed as a part of an apparatus 300 serving other purposes, such as processing data.

A skilled person appreciates that, depending on the embodiment, in addition to the elements shown in FIG. 3, the apparatus 300 comprises other elements, such as further microphones, displays, as well as additional circuitry such as an input/output (I/O) circuitry, memory chips, application-specific integrated circuits (ASIC), a processing circuitry for specific purposes such as a source coding/decoding circuitry, a channel coding/decoding circuitry, a ciphering/deciphering circuitry, and the like.

In certain embodiments, as mentioned, the apparatus 300 comprising the memory 376 and the computer program code 377 is configured to, with the processor 371, cause the apparatus 300 to perform the described method. In certain embodiments, the processor 371 is configured to notice, together with the program code 377, the incoming call. In certain embodiments, as a response to receiving the indication of the incoming call, the processor 371, together with the program code 377, enables that on the user interface 374 it is indicated whether an available space exists and/or it is enabled for a user to book a space. In certain embodiments, the user interface 374 is a display. In certain embodiments, the apparatus 300 is in communication with (i.e., connected to) a space reservation (i.e., a space-booking) system through the communication interface 375.

In certain embodiments, the apparatus of FIG. 3 represents a control system of an office pod. As the office pod is an example of an available space that, depending on the implementation, may or may not be booked, the control system in certain embodiments, is configured to perform the office pod related step(s) of the method presented in the foregoing. Accordingly, in certain embodiments, the control system is e.g. configured to generate the visible indication indicating the availability of the space in question.

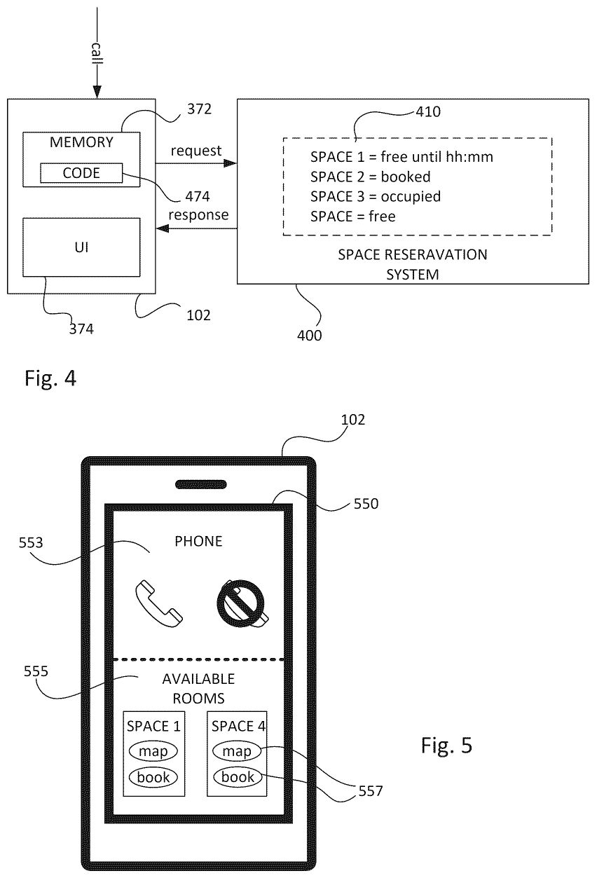

In the following, an example for carrying out a method according to one of the embodiments is described. The example is discussed with reference to FIGS. 4 and 5. In this example, an apparatus 102 is a device capable of taking a phone call, such as a mobile device or a laptop or a tablet device. The apparatus may be the one shown in FIG. 3. The apparatus comprises means for accessing a space reservation system 400 over a network. The network can be interfaced by any communication interface discussed with reference to FIG. 3. The space reservation system 400 may be a computer program being stored in cloud or in a server and comprise means for managing bookings of several rooms or other spaces. For example, the plurality of office booths shown in FIG. 1 may be managed by the space reservation system 400. According to another embodiment, the space reservation system 400 may be an application of one of the office booths shown in FIG. 1 and managing the other office booths in addition to itself. In such embodiment, one of the booths may have a control application that can be extended into space reservation application to control activity and gather information of its own but of other booths as well.

As a result of accessing the space reservation system 400, the apparatus 102 is able to display a view to content 410 of the space reservation system 400 on a user interface 374 of the apparatus 102. According to another embodiment, the apparatus 102 may have a client module for the space reservation system 400 being stored in the memory 372 of the apparatus 102, whereupon the apparatus 102 has the direct access to the content of the space reservation system. For example, a calendar application of the apparatus may also view the booking data obtained from the space reservation system 400.

In order to implement the embodiments of this specification, the apparatus 102 may comprise a program code 474 that is triggered by an incoming phone call. The program code 474 may represent the appropriate application discussed with reference to FIG. 1. The program code 474 may also represent the program code 377 of FIG. 3.

When an incoming call is detected at the apparatus 102, the apparatus 102 may be configured to generate a request for available rooms (i.e., spaces), which request is sent to the space reservation system 400. The request may be automatically generated by the program code 474. The request may contain information concerning location of the apparatus 102. The location information may have been received by the apparatus 102 from an indoor positioning system (which can be any known or future technology) and may be stored in the memory 372 of the apparatus 102. Alternatively, the location information may be requested from the indoor positioning system at the time the request for the space reservation system 400 is being generated. The request may also contain time information, i.e., time of receiving the call or time of generating the request. The time information may help the space reservation system 400 to determine the available space.

The space reservation system 400 receives the request from the apparatus 102, and uses the information contained therein to determine available spaces. The space reservation system 400 uses the location information to identify which spaces are nearby the user, for example on the same floor or within a certain distance. It is to be noticed that if the location information did not indicate any spaces (vacant or occupied) around the user, it may be determined that the user is not located in a place where any office booths or other rooms can even be offered, for example outside the office 100 of FIG. 1, at a shop, at home, etc. Also, it is to be noticed that if the location information matches with one of the spaces being offered, the space reservation system may still offer another space. In such case, the user may be in a meeting in one of the rooms, and may still wish to have another room for a private call. According to an embodiment, the program code 474 residing at the apparatus may function only when it is detected that the user is located in such premises where the space reservation system is operating, for example when the user is located at the office 100 of FIG. 1. That can be done by detecting a user in a wireless network or other internal network arranged to the office. According to another embodiment, the program code 474 may use location information of the user to determine whether the user is at the office, and whether the contact to the space reservation system 400 should be made at all. For example, if the program code 474 detects that user's location information do not match the coverage of the space reservation system 400, meaning that the user is not located at the office, the program code 474 may not generate any requests as a response to detecting a phone call.

In addition, the space reservation system 400 determines from the identified spaces, which of the spaces have not been booked or are not occupied by persons at the time defined in the request. If the request did not contain time information, the space reservation system may use the time when the request was received by the space reservation system.

The booking information is directly available at the space reservation system 400. On the other hand, occupied rooms or spaces can be detected by a presence sensor being arranged at the space. For the latter case, the space reservation system 400 may be aware on occupied spaces in real-time, for example by receiving information concerning change of the status of the space from the presence sensor of the space.

After determining available spaces, the space reservation system 400 is configured to generate a response to be sent to the apparatus 102. The response may contain information on available spaces. The response is received by the program code 474 that is able to generate visual information on the available spaces to be shown on a user interface 374 of the apparatus 102, with or without a possibility for booking. The user interface 374 may be the one as shown also in FIG. 3.

FIG. 5 shows an example of the apparatus 102 with a display 550. Since the aforementioned example occurs at the phone prior the call is actually answered by the user, the content of the display 550 of the apparatus 102 may be split into two UI parts 553, 555, wherein one of the parts 553 shows the UI of the phone application, i.e., UI means to answer or decline the call, and wherein the other part 555 may show at least the available spaces, and optionally also the UI means 557 to perform booking or selection of a space and/or request to show the space on a map. The other part 555 is for the information generated by the program code 474. In this example, the action that splits the screen 550 into several parts 553, 555, each part comprising user interface of an application, is the action of receiving a call at the apparatus 102 and receiving data concerning available spaces from the space reservation system 400. The user may select an action from both parts of the display, i.e., the user may answer the call on the first part 553 showing the UI for the phone application, and may book a space (e.g., SPACE 4) on the second part 555 showing the UI for the data received from the space reservation system. It is to be noted that the selecting can be performed in any order, e.g., the user may first answer the call and then select the space, or the user may first select the space and then answer the call. According to other embodiment, the program code 474 can select the space automatically while the user answers the call. According to yet another embodiment, the space is not booked by the user nor by the program code, but the user just enters the available room, and the room itself can detect the entry by means of the presence sensor and automatically update its status to “occupied”. The space can be automatically freed when it is detected that the user has left the room, e.g., by means of the presence sensor.

As has been discussed, each space may have a control system which may control, for example, “traffic lights” for the space. In addition, the control system may be in communication with a presence sensor to receive data on whether the presence sensor detects people in the space. The control system of the space is in connection with the space reservation system, so that the control system may send presence data to the space reservation system, or that the control system may receive booking data from the space reservation system. By means of the booking data and/or the presence data, the space may change the color of the traffic lights to indicate its availability. In addition, by means of the data received from the space reservation system, the space may change the color of the traffic lights to indicate that the space is the specific space being selected by the user taking the phone call.

Without limiting the scope and interpretation of the patent claims, certain technical effects of one or more of the example embodiments disclosed herein are listed in the following. A technical effect is enabling faster and easier booking of a space upon receiving a call. An additional technical effect is providing improved privacy in a call.

Various embodiments have been presented. It should be appreciated that in this document, words comprise, include, and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method for providing a space to speak on a call, the method comprising:
receiving an indication of an incoming call at a mobile device; and
in response to said receiving an indication of the incoming call at the mobile device,
indicating to a user whether an available space exists for the call.

2. The method according to claim 1, further comprising:
enabling for the user to book the available space.

3. The method according to claim 1, further comprising:
in response to receiving the indication of the incoming call at the mobile device, activating an application at the mobile device for indicating whether an available space exists for the call.

4. The method according to claim 1, further comprising:
showing to the user available spaces nearby.

5. The method according to claim 1, comprising:
booking an available space without user interaction in response to receiving the indication of the call.

6. The method according to claim 1, comprising:
pre-selecting an available space in accordance with a stored user preference.

7. The method according to claim 1, further comprising:
showing to the user locations of available space(s).

8. The method according to claim 5, further comprising:
making the booked space available for others after the user has left the booked space after the call.

9. The method according to claim 1, wherein the space is a confined space or an office booth.

10. The method according to claim 1, wherein in response to said receiving an indication of an incoming call, the method further comprises simultaneously displaying user interfaces for at least two applications on a display of the mobile device, wherein the first user interface is a user interface for a phone application, and wherein the second user interface is a user interface for indicating the available spaces.

11. An apparatus comprising:
a processor; and
a memory including computer program code; the memory and the computer program code being configured to, with the processor, cause the apparatus to
receive an indication of an incoming call at a mobile device; and
in response to said receiving an indication of the incoming call at the mobile device, indicate to a user whether an available space exists for the call.

12. The apparatus according to claim 11, further comprising computer program code configured to cause the apparatus to enable for the user to book the available space.

13. The apparatus according to claim 11, further comprising computer program code configured to cause the apparatus in response to said receiving the indication of the incoming call at the mobile device, to activate an application at the mobile device for indicating whether an available space exists for the call.

14. The apparatus according to claim 11, further comprising computer program code configured to cause the apparatus to show to the user available spaces nearby.

15. The apparatus according to claim 11, further comprising computer program code configured to cause the apparatus to book an available space without user interaction in response to receiving the indication of the call.

16. The apparatus according to claim 11, further comprising computer program code configured to cause the apparatus to pre-select an available space in accordance with a stored user preference.

17. The apparatus according to claim 11, further comprising computer program code configured to cause the apparatus to show to the user locations of available space(s).

18. The apparatus according to claim 11, further comprising computer program code configured to cause the apparatus to make the booked space available for others after the user has left the booked space after the call.

19. The apparatus according to claim 11, wherein the space is a confined space or an office booth.

20. The apparatus according to claim 11, further comprising computer program code configured to cause the apparatus—in response to said receiving an indication of an incoming call—to simultaneously display user interfaces for at least two applications on a display of the mobile device, wherein the first user interface is a user interface for a phone application, and wherein the second user interface is a user interface for indicating the available spaces.

21. A computer program comprising computer executable program code which when executed by a processor causes an apparatus to perform the method of claim 1.
